(19) United States
(12) Patent Application Publication
(10) Pub. No.: US 2025/0066557 A1
(43) Pub. Date: Feb. 27, 2025

(54) POLYMER RESIN MATERIAL COMPOSITION AND MANUFACTURING METHOD THEREOF

(71) Applicant: HONDA MOTOR CO., LTD., Tokyo (JP)

(72) Inventors: Yoshiyasu Kajimoto, Wako-shi (JP); Mitsuharu Kan, Wako-shi (JP); Daisuke Misho, Tokyo (JP); Akihiro Hayashi, Tokyo (JP)

(21) Appl. No.: 18/808,463

(22) Filed: Aug. 19, 2024

(30) Foreign Application Priority Data
Aug. 25, 2023 (JP) 2023-137473

(51) Int. Cl. C08H 7/00; C08L 97/00

(52) U.S. Cl. CPC C08H 6/00; C08L 97/005

(57) ABSTRACT

A polymer resin material composition produced by performing a heat curing treatment on a mixture obtained by mixing epoxidized linseed oil with polyethylene glycol lignin.

### INCORPORATION BY REFERENCE

The present application claims priority under 35 U.S.C. § 119 to Japanese Patent Application No. 2023-137473 filed on Aug. 25, 2023. The content of the application is incorporated herein by reference in its entirety.

### BACKGROUND

### Technical Field

The present invention relates to a polymer resin material composition and a manufacturing method thereof.

### Related Art

In the past, efforts for the purpose of mitigating a climate change or reducing an influence of the climate change have been continuously made, and research and development on reduction of an emission amount of carbon dioxide have been conducted in order to achieve the purpose. In particular, as a technique that can contribute to the reduction of the emission amount of carbon dioxide, there is a technique of producing a plastic material used for manufacturing an electronic component or the like using a biomass raw material.

For example, JP 2008-138061 A discloses a technique of manufacturing an insulating polymer material composition using lignin obtained by blasting a lignin raw material and then performing alcohol extraction, and epoxidized linseed oil. For example, JP 2019-108490 A discloses a technique of manufacturing an epoxy resin using modified lignin chemically modified by polyethylene glycol.

### SUMMARY

The conventional technique has a problem in that it is difficult to manufacture a resin material composition having a high biomass plastic degree at a lower cost. For example, the technique disclosed in JP 2008-138061 A requires a facility that can withstand high temperature and high pressure reaction conditions in the process of manufacturing lignin by blasting. Further, for example, the epoxy resin obtained by the technique disclosed in JP 2019-108490 A has a problem in that a biomass degree is low because the modified lignin chemically modified by polyethylene glycol is used.

Therefore, an object of the present invention is to provide a polymer resin material composition capable of providing a high biomass plastic degree and being manufactured at a low cost, and a manufacturing method of the polymer resin material composition.

One aspect of the present invention is a polymer resin material composition produced by performing a heat curing treatment on a mixture obtained by mixing epoxidized linseed oil with polyethylene glycol lignin.

Another aspect of the present invention is a manufacturing method of a polymer resin material composition, the manufacturing method including: a mixing step of mixing epoxidized linseed oil with polyethylene glycol lignin not dissolved in a solvent to produce a mixture; and a thermal curing step of heating and curing the mixture.

According to the present invention, it is possible to provide a polymer resin material composition capable of achieving a high biomass plastic degree and being manufactured at a low cost, and a manufacturing method of the polymer resin material composition. In addition, another object of the present invention is to contribute to mitigating a climate change or reducing an influence of the climate change.

### BRIEF DESCRIPTION OF DRAWINGS

FIG. 1 is a process diagram showing a manufacturing procedure for a polymer resin composition.

FIG. 2 is a table showing the curing temperature and the curing time in the thermal curing step in step S8 of FIG. 1.

### DETAILED DESCRIPTION

### [1. Polymer Resin Composition]

Epoxidized soybean oil or linseed oil is known as a biomass-based epoxy resin based on vegetable oil. These epoxidized oil-and-fat often have insufficient performance such as reactivity, strength, and glass transition temperature as compared with general epoxy resins, and are less often used for insulating materials. However, in recent years, a biomass-based epoxy resin has been studied by research and development for the purpose of reducing an emission amount of carbon dioxide.

Lignin has attracted attention as one of the biomass-based resin materials. Lignin is a major constituent of plant cell walls and is a compound that accounts for about 30% in wood. For example, Japanese cedar is known as a plant having relatively uniform lignin, and other plants are also available as raw materials for manufacturing lignin. As a method of manufacturing plant-derived lignin, the blasting method described in JP 2008-138061 A may be used, and as lignin that can be manufactured under milder reaction conditions, there is polyethylene glycol lignin. Polyethylene glycol lignin is relatively homogeneous lignin obtained by performing an acid hydrolysis treatment with polyethylene glycol on a lignin raw material derived from wood or the like, and is also called modified lignin.

The present inventors have found that a polymer resin composition which is inexpensive and has a high biomass plastic degree can be obtained by mixing epoxidized linseed oil and modified lignin, and performing a heat curing treatment on the mixture thereof under predetermined conditions. Since the polymer resin material composition obtained by this method has a high glass transition temperature, it can be a material suitable for the manufacture of electronic components and electronic substrates.

The present inventors have also found that a polymer resin material composition having more suitable properties can be obtained by further adding a curing accelerator to the mixture obtained by mixing epoxidized linseed oil and modified lignin. As the curing accelerator, amines, imidazoles, and the like can be used. The curing accelerator accelerates a chemical reaction between the epoxidized linseed oil and the modified lignin serving as a curing agent in the process of curing the mixture obtained by mixing the epoxidized linseed oil and the modified lignin, and exhibits effects such as accelerating a curing time and increasing a glass transition temperature of the polymer resin material composition as a product. As the curing accelerator, 2-ethyl-4-methylimidazole (hereinafter, 2E4MZ) was particularly suitable.

The polymer resin material composition manufactured by the method found by the present inventors has an advantage of having a high biomass plastic degree. Here, the biomass plastic degree was measured by a method of measuring a 14C concentration defined by ISO16620. That is, by measuring the ratio of 14C of a product, an amount of carbon derived from biomass can be determined, and the biomass plastic degree is determined based on the determined amount.

### [2. Manufacture of Polymer Resin Composition]

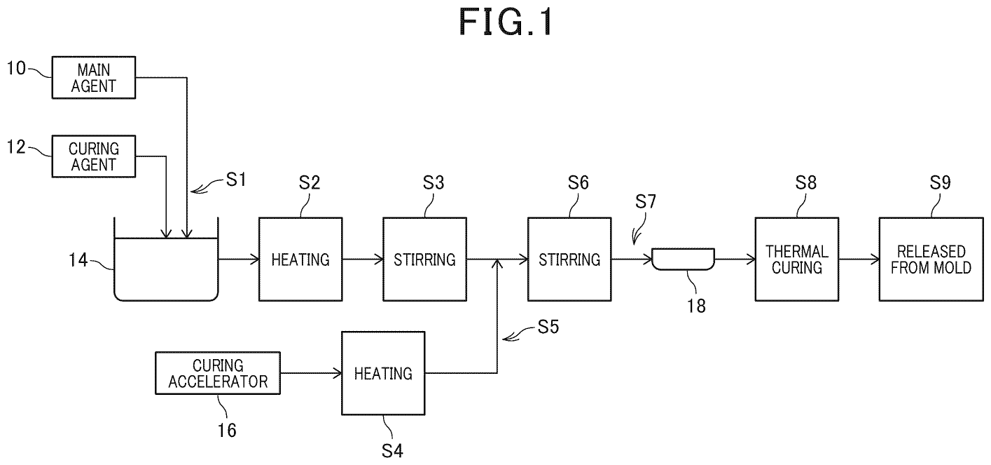

FIG. 1 is a process diagram showing a manufacturing procedure for a polymer resin composition.

In the manufacturing method for the polymer resin composition of the present disclosure, first, a main agent 10 composed of a biomass-based epoxy resin based on vegetable oil and a curing agent 12 composed of modified lignin are charged into a stirrer 14, and a first mixing step (step S1) of stirring and mixing the main agent 10 and the curing agent 12 in the stirrer 14 is performed.

In the first mixing step, in the stirrer 14, the main agent 10 and the curing agent 12 that is composed of the modified lignin and is not dissolved in a solvent are mixed to obtain a mixture thereof.

The main agent 10 is, for example, epoxidized linseed oil. The curing agent 12 is, for example, powdered or granular polyethylene glycol lignin that is not dissolved in a solvent. In the first mixing step, 100 parts by mass of polyethylene glycol lignin is charged into the stirrer 14 with respect to 100 parts by mass of epoxidized linseed oil, and mixed. This is one example, and for example, even when polyethylene glycol lignin is mixed at a ratio of 75 parts by mass or more and 125 parts by mass or less with respect to 100 parts by mass of epoxidized linseed oil, a suitable polymer resin composition can be obtained.

Subsequently, a heating step (step S2) of heating the mixture mixed by the stirrer 14 is executed. Furthermore, the main agent 10 and the curing agent 12 melted by heating are further stirred (step S3). The steps of steps S2 and S3 are performed in a state in which the mixture is contained in the stirrer 14. In the heating step of step S2, a heating device (not illustrated) that is provided in the stirrer 14 and heats the inside of a tank of the stirrer 14 or the entire stirrer 14 is used. The temperature and time for heating the mixture in step S2 are set to a temperature and time at which the main agent 10 and the curing agent 12 are entirely melted.

In a container different from the stirrer 14, 2E4MZ serving as the curing accelerator 16 is heated and melted (step S4). The melted 2E4MZ is added to the mixture stirred in step S3 (step S5). Step S5 is referred to as an addition step, and in the addition step, for example, 2E4MZ is charged into the stirrer 14 that stores the mixture stirred in step S3.

After the addition step of step S5, the mixture is further stirred (step S6). Steps S5 and S6 are examples of the second mixing step, and the first mixing step and the second mixing step are included in the mixing step of the present disclosure. The step of step S6 is executed in the stirrer 14. The entire steps of steps S1 to S6 may be included in the mixing step. Subsequently, the mixture obtained in the second mixing step (steps S5 and S6) is cast into a mold 18 (step S7).

After the casting step in step S7, the mold 18 is heated in an oven so as to heat the mixture injected into the mold 18 to a curing temperature (step S8). Step S8 corresponds to an example of a thermal curing step. Thereafter, the polymer resin composition heated in step S8 is released from the mold 18 (step S9) so as to obtain a polymer resin composition having a biomass plastic degree of 100% or more.

In the thermal curing step in step S8, the mixture is heated at a temperature of 160° C. or higher and 200° C. or lower for 17 hours or longer and 24 hours or shorter.

When the curing accelerator 16 (2E4MZ or the like) is not added, steps S4, S5, and S6 are omitted. In this case as well, heating is performed at 170° C. or higher and 200° C. or lower for 17 hours or longer and 24 hours or shorter in the thermal curing step.

As shown in examples to be described later, a polymer resin material composition obtained by the manufacturing method of the present disclosure has a glass transition temperature Tg of 90° C. or higher as measured by a method described in ISO11359-2 using thermomechanical analysis (TMA). A suitable glass transition temperature Tg of a resin material used for manufacturing an electronic component or an electronic substrate is 90° C. or higher, more preferably 95° C. or higher, and still more preferably 100° C. or higher. Therefore, according to the manufacturing method of the polymer resin material composition of the present disclosure, a polymer resin material composition suitable for electronic components and electronic substrates can be manufactured inexpensively under mild temperature and pressure conditions.

In the manufacturing method of the polymer resin composition of the present disclosure, the mixing step includes the first mixing step and the second mixing step. In the first mixing step, the main agent 10 and the curing agent 12 that is not dissolved in the solvent are heated and melted to be mixed. In the second mixing step, the heated and melted curing accelerator 16 is mixed with the mixture of the main agent 10 and the curing agent 12 in a heated and melted state. In the second mixing step, 1 part by mass of the curing accelerator 16 is mixed with respect to 100 parts by mass of the main agent 10. The amount of the curing accelerator 16 can be appropriately changed, but for example, it is preferable to mix 1 part by mass or less of the curing accelerator 16 with respect to 100 parts by mass of the main agent 10. As an example, the main agent 10 is epoxidized linseed oil and the curing agent 12 is polyethylene glycol lignin that is not dissolved in a solvent.

### 3. Examples

Next, the polymer resin material composition of the present disclosure and the manufacturing method thereof will be specifically described based on examples. The present disclosure is by no means limited by these examples.

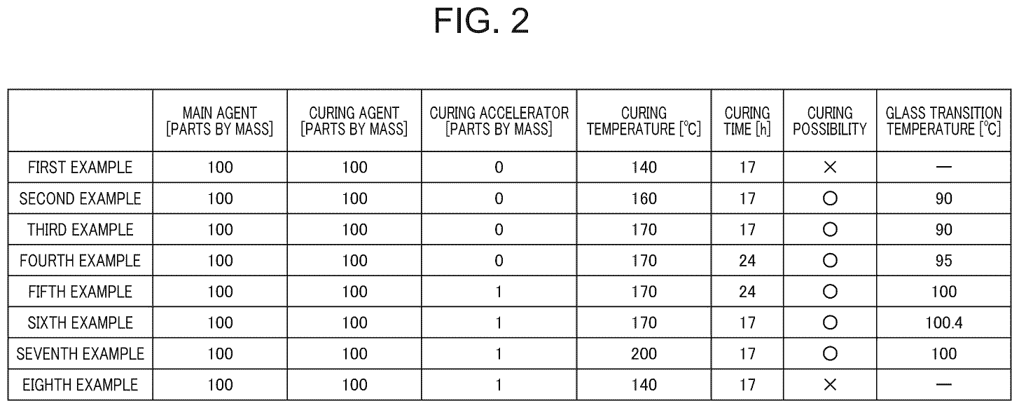

Examples of manufacturing polymer resin material compositions by the manufacturing method of the present disclosure by variously changing the amounts of the main agent 10, the curing agent 12, and the curing accelerator 16 are shown as first to eighth examples. FIG. 2 shows an amount of the main agent 10, an amount of the curing agent 12, an amount of the curing accelerator, a curing temperature, a curing time, a curing possibility, and the glass transition temperature Tg for each of the first to eighth examples. In FIG. 2, the amount of the curing agent 12 and the amount of the curing accelerator are shown in parts by mass when the amount of the main agent 10 is 100 parts by mass. In the curing possibility, whether or not practical physical properties as a polymer resin composition are satisfied is indicated by ∘ and x. Here, ∘ is an example in which the practical physical properties are satisfied, and x is an example in which the practical physical properties are not satisfied. The practical physical properties as a polymer resin composition refer to having mechanical strength equivalent to or comparable to that of a conventional epoxy resin, and specifically include flexural modulus and flexural strength (flexural stress). The flexural modulus and the flexural strength of the polymer resin material composition manufactured in each of the first to eighth examples were measured, and when the measured value of the flexural modulus was equal to or greater than a reference value and the measured value of the flexural strength was equal to or greater than a reference value, the measured value was determined as ∘.

The curing temperature and the curing time in FIG. 2 are the curing temperature and the curing time in the thermal curing step in step S8 (FIG. 1).

As shown in the table of FIG. 2, in the first to eighth examples, 100 parts by mass of the curing agent 12 was used with respect to 100 parts by mass of the main agent 10. Epoxidized linseed oil was used as the main agent 10, and specifically, ADEKA CIZER O-180 manufactured by ADEKA Corporation was used. The curing agent 12 is powdered or granular polyethylene glycol lignin that is not dissolved in a solvent. Specifically, lignin SR4 manufactured by LignoMateria Co., Ltd. was used. The curing agent 12 is powdered or granular lignin in which a D50 particle diameter is equal to or greater than 190 μm and equal to or less than 290 μm.

In the first to fourth examples, the curing accelerator 16 is not added. In the fifth to eight examples, 2E4MZ (2-ethyl-4-methylimidazole) manufactured by FUJIFILM Wako Pure Chemical Corporation was mixed as the curing accelerator 16. The amount of the curing accelerator 16 was 1 part by mass with respect to 100 parts by mass of the main agent 10.

In all of the results of the second to seventh examples, the evaluation of curing possibility was determined as ∘, and the manufactured polymer resin material composition satisfies practical physical properties as a polymer resin composition. In addition, the polymer resin material compositions obtained in the second to seventh examples all had a glass transition temperature Tg of 90° C. or higher.

From the results of the second to seventh examples, it was found that a polymer resin material composition having mechanical strength comparable to that of a conventional epoxy resin can be provided by using a biomass raw material.

From the results of the second to seventh examples, in the manufacture of the polymer resin material composition having the glass transition temperature of 90° C. or higher, the curing time may be 17 hours or longer. From the results of the fourth and fifth examples, when the curing time was extended, there was no significant difference in the glass transition temperature Tg up to 24 hours. Therefore, the heating time in the thermal curing step is preferably 17 hours or longer and 24 hours or shorter.

From the results of the second to seventh examples, the curing temperature is desirably 160° C. or higher, and more preferably 170° C. or higher. From the results of the second to fourth examples, it was found that even when a curing accelerator was not added, the conditions of the heating time of 17 hours or longer and 24 hours or shorter and the heating temperature of 160° C. or higher were favorable. In addition, it was found from the seventh example that the heating temperature was good up to 200° C.

Furthermore, from a comparison result among the fifth example, the sixth example, and the seventh example, it was found that there is no large difference in the glass transition temperature Tg up to 200° C. as the heating temperature. Therefore, when at least a curing accelerator is added, the curing temperature may be 170° C. or higher and 200° C. or lower.

When the curing agent 12 has a powdery shape or a granular shape in which a D50 particle diameter is equal to or less than 290 μm, preferably equal to or greater than 190 μm, the curing agent 12 is mixed normally even if it is mixed with the main agent 10 in a state of not being dissolved in a solvent.

The effect of the curing accelerator is apparent from the results of the fifth to eighth examples. That is, in the example in which 1 part by mass of 2E4MZ was mixed as the curing accelerator 16 with respect to 100 parts by mass of the main agent 10 and 100 parts by mass of the curing agent 12, a particularly favorable result indicating that the glass transition temperature Tg was 100° C. or higher was obtained.

In addition, in the first and eighth examples, the evaluation of curing possibility was determined as x, and the obtained polymer resin material composition caused slight deterioration in physical properties. From the results of the first and eighth examples, the heating temperature in the thermal curing step is desirably higher than 140° C., and more preferably 160° C. or higher as described above.

### 4. Other Embodiments

The above-described embodiment merely illustrates one aspect of the present invention, and can be arbitrarily modified and applied within the scope of the present invention.

In the above-described embodiment, an example in which 100 parts by mass of the curing agent 12 is mixed with 100 parts by mass of the main agent 10 has been described, but this is an example, and it is possible to adjust the ratio of the main agent 10, the curing agent 12, and the curing accelerator 16 as necessary.

In the above-described embodiment, an example in which the stirrer 14 is used in the step of mixing the main agent 10, the curing agent 12, and the curing accelerator 16 has been described. However, for example, each step of steps S2, S3, and S6 may be performed using a container or a device different from the stirrer 14.

In the thermal curing step in step S8 described in the above-described embodiment, two-stage heating at different heating temperatures, residual heat treatment, pre-drying, and the like may be appropriately performed.

### 5. Configurations Supported by Above-Described Embodiment

The above embodiment supports the following configurations.

(Configuration 1) A polymer resin material composition produced by performing a heat curing treatment on a mixture obtained by mixing epoxidized linseed oil with polyethylene glycol lignin.

With the polymer resin material composition of configuration 1, it is possible to obtain a polymer resin material composition that uses epoxidized linseed oil as a biomass raw material and lignin and that has a biomass plastic degree of 100% or more. This polymer resin material composition can be manufactured without using a high-cost means such as blasting. Therefore, it is possible to provide a polymer resin material composition capable of proving a high biomass plastic degree and being manufactured at a low cost.

(Configuration 2) The polymer resin material composition according to configuration 1, in which a glass transition temperature Tg of the polymer resin material composition is 90° C. or higher.

With the polymer resin material composition of configuration 2, it is possible to provide a polymer resin material composition that has a high biomass plastic degree, can be manufactured at a low cost, and has a high glass transition temperature Tg suitable for use in electronic components and electronic substrates.

(Configuration 3) The polymer resin material composition according to configuration 1 or 2, in which the mixture is manufactured by mixing 75 parts by mass or more and 125 parts by mass or less of the polyethylene glycol lignin with 100 parts by mass of the epoxidized linseed oil.

With the polymer resin material composition of configuration 3, it is possible to obtain a polymer resin material composition that has a high biomass plastic degree, can be manufactured at a low cost, and has excellent physical properties.

(Configuration 4) A manufacturing method of a polymer resin material composition, the manufacturing method including: a mixing step of mixing epoxidized linseed oil with polyethylene glycol lignin not dissolved in a solvent to produce a mixture; and a thermal curing step of heating and curing the mixture.

According to the manufacturing method of a polymer resin material composition of configuration 4, it is possible to obtain a polymer resin material composition that uses epoxidized linseed oil as a biomass raw material and lignin and that has a biomass plastic degree of 100% or more. This manufacturing method includes a step of mixing lignin with epoxidized linseed oil without dissolving the lignin in a solvent, and uses polyethylene glycol lignin that can be obtained without using a high-cost means such as blasting. Therefore, it is possible to provide a polymer resin material composition capable of proving a high biomass plastic degree and being manufactured at a low cost.

(Configuration 5) The manufacturing method of a polymer resin material composition according to configuration 4, in which the mixing step includes: a first mixing step of thermally melting and mixing the epoxidized linseed oil and the polyethylene glycol lignin not dissolved in a solvent; and a second mixing step of mixing a heated and melted curing accelerator with the mixture of the epoxidized linseed oil and the polyethylene glycol lignin in a heated and melted state, and in the second mixing step, 1 part by mass or less of the curing accelerator is mixed with 100 parts by mass of the epoxidized linseed oil.

According to the manufacturing method of a polymer resin material composition of configuration 5, epoxidized linseed oil and polyethylene glycol lignin are mixed without dissolving the polyethylene glycol lignin in a solvent, and the mixture is more reliably cured by a curing accelerator. As a result, a polymer resin material composition having a high biomass plastic degree and excellent physical properties can be manufactured at a lower cost.

(Configuration 6) The manufacturing method of a polymer resin material composition according to configuration 4 or 5, in which, in the thermal curing step, the mixture is heated under conditions of 160° C. or higher and 200° C. or lower for 17 hours or longer and 24 hours or shorter.

According to the manufacturing method of a polymer resin material composition of configuration 6, epoxidized linseed oil and polyethylene glycol lignin can be more reliably cured, and a polymer resin material composition having a high biomass plastic degree and excellent physical properties can be manufactured at a lower cost.

(Configuration 7) The manufacturing method of a polymer resin material composition according to configuration 5, in which the mixture mixed with the curing accelerator in the second mixing step is heated at 170° C. or higher and 200° C. or lower for 17 hours or longer and 24 hours or shorter in the thermal curing step.

According to the manufacturing method of a polymer resin material composition of configuration 7, epoxidized linseed oil and polyethylene glycol lignin can be more reliably cured by a curing accelerator, and a polymer resin material composition having a high biomass plastic degree and excellent physical properties can be manufactured at a lower cost.

(Configuration 8) The manufacturing method of a polymer resin material composition according to configuration 5 or 7, in which 2-ethyl-4-methylimidazole is mixed as the curing accelerator.

According to the manufacturing method of a polymer resin material composition of configuration 8, a polymer resin material composition having a high biomass plastic degree can be manufactured at a lower cost.

### REFERENCE SIGNS LIST

10 Main agent
12 Curing agent
14 Stirrer
16 Curing accelerator
18 Mold

What is claimed is:

1. A polymer resin material composition produced by performing a heat curing treatment on a mixture obtained by mixing epoxidized linseed oil with polyethylene glycol lignin.

2. The polymer resin material composition according to claim 1, wherein a glass transition temperature Tg of the polymer resin material composition is 90° C. or higher.

3. The polymer resin material composition according to claim 1, wherein the mixture is manufactured by mixing 75 parts by mass or more and 125 parts by mass or less of the polyethylene glycol lignin with 100 parts by mass of the epoxidized linseed oil.

4. A manufacturing method of a polymer resin material composition, the manufacturing method comprising:
a mixing step of mixing epoxidized linseed oil with polyethylene glycol lignin not dissolved in a solvent to produce a mixture; and
a thermal curing step of heating and curing the mixture.

5. The manufacturing method of a polymer resin material composition according to claim 4, wherein:
the mixing step includes:
a first mixing step of thermally melting and mixing the epoxidized linseed oil and the polyethylene glycol lignin not dissolved in a solvent; and
a second mixing step of mixing a heated and melted curing accelerator with the mixture of the epoxidized linseed oil and the polyethylene glycol lignin in a heated and melted state, and
in the second mixing step, 1 part by mass or less of the curing accelerator is mixed with 100 parts by mass of the epoxidized linseed oil.

6. The manufacturing method of a polymer resin material composition according to claim 4, wherein, in the thermal curing step, the mixture is heated under conditions of 160° C. or higher and 200° C. or lower for 17 hours or longer and 24 hours or shorter.

7. The manufacturing method of a polymer resin material composition according to claim 5, wherein the mixture mixed with the curing accelerator in the second mixing step is heated at 170° C. or higher and 200° C. or lower for 17 hours or longer and 24 hours or shorter in the thermal curing step.

8. The manufacturing method of a polymer resin material composition according to claim 5, wherein 2-ethyl-4-methylimidazole is mixed as the curing accelerator.
